(19) United States
(12) Patent Application Publication
(10) Pub. No.: US 2024/0119548 A1
(43) Pub. Date: Apr. 11, 2024

(54) Systems and Methods for Licensing, Distribution, and Sales Automation

(71) Applicant: Charles E. Shoffner, Greenville, SC (US)

(72) Inventor: Charles E. Shoffner, Greenville, SC (US)

(21) Appl. No.: 18/545,304

(22) Filed: Dec. 19, 2023

Related U.S. Application Data
(63) Continuation-in-part of application No. 17/368,327, filed on Jul. 6, 2021.
Application No. 17/368,327 is a continuation of application No. 16/104,418, filed on Aug. 17, 2018, now abandoned.
(60) Provisional application No. 62/547,326, filed on Aug. 18, 2017.

(51) Int. Cl. G06Q 50/18; G06Q 50/16

(52) U.S. Cl. CPC G06Q 50/18; G06Q 50/16; G06Q 2220/18

(57) ABSTRACT

A system and method for automating licensing, distribution, and sales for goods and/or services. A method includes receiving, at a management platform, a lead identifier, determining, at the management platform, whether one or more lead requirements has been satisfied by the lead identifier, sending, by the management platform, an electronic approval request for the lead identifier, and receiving, at the management platform, an answer responding to the electronic approval request. In response to receiving the answer, the method includes automatically forwarding, by the management platform, an electronic license and distribution request to an entity associated with the lead identifier.

### CROSS-REFERENCE TO RELATED APPLICATION

The present application claims priority to, and is a continuation-in-part application of, U.S. patent application Ser. No. 17/368,327, filed Jul. 6, 2021, which is a continuation of U.S. patent application Ser. No. 16/104,418, filed on Aug. 17, 2018, which claims priority to U.S. Provisional Patent Application 62/547,326, filed Aug. 18, 2017, the disclosures of which are herein incorporated by reference in their entireties.

### TECHNICAL FIELD

Embodiments of the present disclosure relate to systems and methods for performing automated licensing, distribution, and sales.

### BACKGROUND

Licensors of various technologies, companies, goods, and/or services face many challenges. Such challenges include, for example, increasing product distribution and sales while also growing and developing licensees. Licensors expend significant amounts of time and money in recruiting, developing, and managing potential leads to whom their brands will be licensed. Difficulties in managing leads increase as the quantity of leads increases and/or the quantity of qualifications a lead must satisfy prior to becoming a licensee increases.

In view of these challenges, a need exists for methods, systems, and computer readable media for automated licensing, distribution, and sales.

### SUMMARY

The subject matter described herein relates to methods, systems, and non-transitory computer readable media for automated licensing, distribution, and sales. Such methods and systems advantageously trigger or prompt leads, licensees, and licensors, automatically, to submit various information or data and/or perform various actions necessary to automatically form a license. The methods and systems described herein benefit both licensees and licensors by ensuring consistent license formation, while facilitating swift and automated license termination where the licensee or licensor fail to comply with the terms or conditions set forth therein.

In an exemplary embodiment, a method for automating licensing, distribution, and sales for goods and/or services is provided. The method includes receiving, at a management platform, a lead identifier, determining, at the management platform, whether one or more lead requirements has been satisfied by the lead identifier, sending, by the management platform, an electronic approval request for the lead identifier, and receiving, at the management platform, an answer responding to the electronic approval request. In response to receiving the answer, the method includes automatically forwarding, by the management platform, an electronic license and distribution request to an entity associated with the lead identifier.

In an exemplary embodiment, a method for automated licensing, distribution, and sales comprises receiving, at a management platform, a lead identifier, determining, at the management platform, satisfaction of one or more lead requirements by the lead identifier, triggering, by the management platform, transmission of an electronic approval request for the lead identifier, and receiving, at the management platform, an answer approving or disapproving the electronic approval request. In response to receiving the answer, the method further comprises automatically forwarding an electronic license and distribution request to an entity associated with the lead identifier.

In an exemplary embodiment, a system for automating licensing, distribution, and sales is also provided. The system comprises a management platform comprising a processor, memory, and a communications interface. The processor is configured to execute one or more computing modules stored in the memory for receiving a plurality of lead identifiers, determining completion of one or more lead requirements by the lead identifiers, triggering transmission of electronic approval requests for the lead identifiers, receiving answers approving or disapproving the electronic approval requests, and in response to receiving the answers, automatically forwarding electronic license and distribution requests to entities associated with the lead identifiers.

The subject matter described herein may be implemented in hardware, software, firmware, or any combination thereof. As such, the term “module” as used herein refers to hardware, which may also include software and/or firmware components, for implementing the feature being described.

In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

According to various embodiments, the executable instructions, when executed by the processor, may further configured to cause the processor to perform the step of, upon receiving the answer to the electronic approval request, generating a portal account, accessible on a graphical user interface, for the entity associated with the lead identifier.

According to various embodiments, the portal account may be configured to enable the entity to perform one or more of: accessing compliance information; or indicating one or more dealership changes.

According to various embodiments, the one or more dealership changes may comprise one or more of the following: an addition of one or more associates; an addition of a location; a moving of a location; a closing of a location; or a selling of a location.

According to an object of the present disclosure, a method of automating licensing, distribution, and sales is provided. The method may comprise selection of a territory from a potential dealer receiving (using a computing device comprising a processor and a memory), and determining whether the territory is taken (using the computing device). When the territory is taken, the method includes signing up the potential dealer to a waiting list (using the computing device) and determining whether a dealer associated with the territory is deactivated (using the computing device). The method also includes when the dealer associated with the territory is deactivated, (i) sending notice to the potential dealer (using the computing device) and (ii) determining, at a management platform, whether one or more lead requirements has been satisfied by the potential dealer, and (iii) sending, by the management platform, an electronic approval request for the lead identifier.

According to various embodiments, the method may further comprise receiving, at the management platform, an answer responding to the electronic approval request, and, in response to receiving the answer, automatically forwarding, by the management platform, an electronic license and distribution request to an entity associated with the lead identifier.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 is a of a network diagram illustrating methods and systems for automated licensing, distribution, and sales according to some embodiments described herein.

FIG. 2 is a block diagram of a system for automated licensing, distribution, and sales according to some embodiments described herein.

FIG. 3 is a message flow diagram for methods and systems for automated licensing, distribution, and sales according to one embodiment described herein.

FIG. 4 is a flowchart of a method for performing an automated and generally fully integrated waiting list feature according to some embodiments described herein.

FIG. 5 is a flowchart of a method for performing an automated and generally fully integrated radius buffer feature according to some embodiments described herein.

FIG. 6 is a flowchart of a method for performing an automated and generally fully integrated radius adjustment override feature according to some embodiments described herein.

FIG. 7 illustrates example elements of a computing device according to some embodiments described herein.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

Hereinafter, some embodiments of the present disclosure will be described in detail with reference to the drawings. In the drawings, the same reference numerals will be used throughout to designate the same or equivalent elements. In addition, a detailed description of well-known features or functions will be ruled out in order not to unnecessarily obscure the gist of the present disclosure.

In the following detailed description, numerous details are set forth in order to provide an understanding of a wagering program; however, it will be understood by those skilled in the art that different and numerous embodiments of the wagering program and the method of operation may be practiced without those specific details, and the claims and disclosure should not be limited to the embodiments, subassemblies, features, processes, methods, aspects, features or details specifically described and shown in the present disclosure. Further, particular features described in the present disclosure can be used in combination with other described features in each of the various possible combinations and permutations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

The following detailed description omits or only briefly describes conventional features of a casino, which are apparent to those skilled in the art. Moreover, unless otherwise specifically defined in the present disclosure, all terms are to be given their broadest possible interpretation including meanings implied from the specification as well as meanings understood by those skilled in the art and/or as defined in dictionaries, treatises, etc.

The subject matter set forth herein relates to methods, systems, and non-transitory computer readable media for automated licensing, distribution, and sales. The systems and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the instant disclosure.

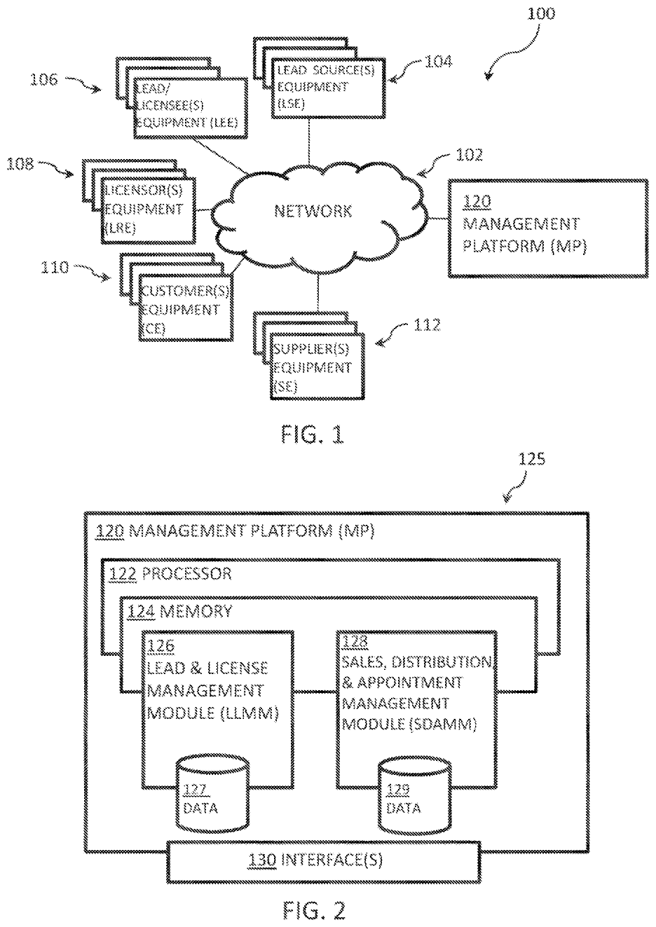

FIG. 1 is a schematic diagram illustrating an exemplary network environment or network architecture 100 associated with the automated licensing, distribution, and sales of goods or services according to an embodiment of the subject matter described herein. The network architecture 100 can facilitate the automatic formation and/or termination of licenses, contracts, or any other type of agreement (e.g., franchise agreements) not inconsistent with the instant disclosure. The licenses (agreements) may be formed and/or terminated in response to various triggers. Such triggers may be conditioned on the accomplishment of (or failure to accomplish) various tasks or objectives identified by the licensee, the licensor, or any other person or entity not inconsistent with the instant disclosure. Automating license formation and termination is advantageously more consistent and simplified. Such benefits are further realized where the quantity of leads for a given licensor is large and/or the quantity of requirements that must be satisfied in order for a lead to be considered eligible for upgrading to a licensee is expansive. Notably, the network architecture 100 obviates the need for the traditional (i.e., manual) methods of verifying completion of lead requirements and/or approving licensees.

As FIG. 1 illustrates, multiple entities are configured to access a communications network 102 and communicate with each other for automating license formation or termination and/or electronically initiating the distribution and sales of goods or services. Such entities include one or more of lead source equipment (LSE) 104, lead/licensee equipment (LEE) 106, licensor equipment (LRE) 108, customer equipment (CE) 110, supplier equipment (SE) 112, and a management platform (MP) 120. As used herein, the term “equipment” refers to mobile or non-mobile communications devices including, but not limited to phones, computers (e.g., laptop computers, tablet computers, desktop computers, etc.), processing devices, smart devices, smart planners or organizers, smart televisions, wearable computers (e.g., a watch, an eyeglass mounted computer, etc.), Internet enabled devices, or any combination thereof. Any other type of network communications equipment not inconsistent with the instant disclosure is also contemplated. The various entities can access and communicate data via network 102 to automatically form and/or terminate licenses and also initiate distribution and sales of goods or services.

The communications network 102 can comprise any type of network not inconsistent with the instant disclosure. For example and in certain embodiments, the network 102 comprises a packet-based communications network (e.g., the Internet) accessed by the various entities (i.e., 104, 106, 108, 110, and 112). Such entities may access the network 102 via a wired or wireless interface (e.g., a WAN, a LAN, a Wi-Fi connection, a radio access connection, etc.) disposed on and/or associated with the respective user equipment. Although not shown for illustration purposes only, each entity (i.e., 104, 106, 108, 110, and 112) associated with the architecture 100 may reside in an individual (e.g., public or privately managed) network, which may include a same network or different networks. Notably, network 102 facilitates the communication of data via packets or packet-based messages, which may be communicated between network entities according to any desired communication protocol as known in the art (e.g., IP, HTTP, TCP, UDP, SIP, etc.). Although a packet-based network is shown for illustrative purposes only, the subject matter described herein is not limited to a packet-based network. Any type of communications network 102 through which messages and/or data can be exchanged electronically between computing entities or platforms may be used without departing from the scope of the subject matter described herein. Such networks may include packet-based networks, circuit-switched networks, or combinations of packet-based and circuit-switched networks.

Referring now to the various network entities associated with architecture 100, each entity can communicate or exchange data with MP 120, which is configured to automate the formation and/or termination of one or more licenses between at least one LEE 106 and LRE 108. Initially, prior to license formation, information regarding a plurality of “leads” is sent to MP 120. As used herein, the terms “lead” and “leads” refer to potential licensees for a licensor's tangible or intangible assets. Leads may be individuals, groups of individuals, or business entities. The LSEs 104 are configured to collect, aggregate, and periodically send lead information to MP 120. Exemplary lead information includes, without limitation, identifying information such as the lead's name, a lead identifier, a business name, a phone number, an email address, a residential address, a business address, or any other type of information by which a licensor may use to identify and/or contact a lead. Exemplary LSEs 104 include clearing houses, recruiters, head hunters, or any other type of lead collecting and aggregating entity not inconsistent with the instant application. LSEs 104 are configured to identify individuals and/or businesses having an interest in licensing tangible or intangible assets from LRE 108 and send identifying information to MP 120. MP 120 is configured to receive the lead information from LREs 104, determine satisfaction of one or more lead requirements, and set and execute various triggers. An exemplary trigger includes automatically sending an electronic license or licensee approval request to LRE 108 upon determining that a lead has satisfied each and every lead requirement. Another exemplary trigger includes automatically forwarding an electronic license and distribution request to each lead that LRE 108 approves as a licensee. According to various embodiments, another exemplary trigger includes automatically generating an email address for each lead that LRE 108 approves as a licensee. Also, according to an exemplary embodiment, another exemplary trigger includes generating a checklist for setting up a dealership account. The checklist may comprise, e.g., setting up one or more social media accounts, storing one or more phone numbers and/or email addresses, and/or other suitable checklist items. The checklist may comprise one or more accounts and/or pieces of information needed prior to the licensee making a first order.

According to various embodiments, another exemplary trigger includes generating a dealer portal account for, and/or enabling access to the dealer portal account to, each lead that LRE 108 approves as a licensee after license formation. Consistent with various embodiments, the dealer portal may be configured to enable data transfers between the dealer and the MP 120, configured to enable a dealer to access compliance information (e.g., notifications concerning failure to maintain compliance) and/or configured to enable a dealer to indicate one or more dealership changes, such as, for example, the addition of one or more associates, the addition of a location, the moving of a location, the closing of a location, the selling of a location, and/or other suitable dealership changes.

According to various embodiments, sales data, for each new order, may be automatically transferred and/or stored with the MP 120 via an inhouse and/or third party sales portal (e.g., the Magento (https://omsdocs.magento.com/) sales portal and/or other suitable sales portal). New order data may be used for generating one or more reports, for determining compliance and/or for one or more other suitable purposes.

According to various embodiments, the MP 120 may be configured to manage user compliance via a number of methods. For example, the MP 120 may be configured: to access and/or control a mailed letter system for generating and/or sending default and/or breach notices; to request voluntary deactivation of one or more users; to cause forced deactivation; to generate and/or send one or more deactivation notices; to execute territory agreement (TA) initiative implementation; to cause a location buyout process to be performed; and/or to enact one or more other suitable dealer management actions.

According to a non-limiting example, the MP 120 may be configured to manage dealer compliance via: managing a mailed letter system for default and/or breach notices; requesting voluntary deactivation of one or more users; implementing forced deactivation; generating and/or transmitting/sending one or more deactivation notices; executing the TA initiative implementation; performing a location buyout process; and/or implementing one or more other suitable dealer compliance management actions.

According to various embodiments, the TA implementation may be implemented as an alternative to placing a low volume dealer into default and then, if the default is not cured, into termination of their TA. Under the TA initiative implementation, the system may be programmed to offer low volume dealers an opportunity to stay as licensed dealers, but with only a limited protected territory (e.g., a quarter of a mile protected territory as opposed to, e.g., a territory of either 10 miles or 100,000 in population). Additionally, under the TA initiative implementation, the territory of a low volume dealer may be immediately placed on one or more recruiting maps as “available,” enabling the volume being generated by the low volume dealer(s) to be kept (rather not being kept when the low volume dealer is terminated) while the low volume dealer's territory is marketed to new dealers. The TA initiative implementation also gives the under-performing dealer time to save their territory if the low volume dealer's volume goes up before a new dealer is recruited to the territory. Similarly, dealers who exceed sales volumes may be offered bonuses, one or more additional territories, additional product lines and/or other benefits or incentives.

According to another non-limiting example, a dealer's portal access may be configured with one or more trigger features (e.g., buttons, etc.) configured to trigger one or more semi and/or fully automated systems. These semi and/or fully automated systems may comprise: systems for adding a new associate (this may trigger a confidentiality agreement and/or a consent to be bound agreement); systems for adding a location; systems for moving a location; systems for closing a location; systems for selling a location with no buyer; systems for selling a location with a buyer and/or other suitable systems.

### EXAMPLE

One nonlimiting example implementation of the present disclosure may include a process (which may be performed by MP 120) for managing compliance including:
   Generating a mailed letter system for default and breach notices
   Voluntary deactivation by a dealer
   Forced deactivation of a dealer
   Generating deactivation notices to vendors
   Initiation of a location buyout process
MP 120 may include a dealer portal for allowing dealers to access and to trigger automated systems, including:
   Adding new associate—triggers generation of confidentiality agreement, consent to be bound agreement, etc.
   Adding a new location
   Moving a location
   Closing a location
   Selling a location (where there is no known no buyer)
   Selling a location (where one or more buyers are known)

In some cases, prior to license formation, MP 120 is further configured to determine whether a lead has satisfied one or more requirements. Such requirements may be set or specified by LRE 108, LEE 106, or a combination thereof. Once all (or a specified number) of the lead requirements are satisfied, a lead is upgraded to a licensee pending approval by LRE 108. Exemplary lead requirements can comprise, without limitation, payment of one or more fees, securing a contract for the sale, lease, or rental of real property suitable for a business location for approval by LRE 108, confirmation of formation of a corporate or business entity in a specified jurisdiction (i.e., a specified state or country), confirmation of meeting minimum net worth requirements, confirmation of meeting desired work experience, educational background, and/or capital requirements, or any other requirement set forth by a given licensor. MP 120 receives, from LEE 106, electronic confirmation and/or verification of meeting or not meeting the various lead requirements. Once all (or a specified number) of the lead requirements are met and a lead is approved by LRE 108, a license is automatically sent to LEE 106 for execution. Upon receipt of an electronic approval of the license by both LRE 108 and LEE 106, a license, contract, and/or agreement automatically forms. Similarly, the license, contract, or agreement may also be terminated for failure to comply with the terms or conditions set forth therein by LEE 106 or LRE 108.

Upon and/or simultaneous with contract formation, LEE 106 can place one or more orders for goods and/or services via MP 120. For example, upon a request from LEE 106, MP 120 can generate and send an order or distribution request to SE 112. SE 112 is a seller (dealer) or distributor of goods and/or services. MP 120 can automate the sales and distribution of the goods and services, while managing and tracking sales data. MP 120 can collect, account, and optionally report sales data and information to LREs 108. Using the reported information, LREs 108 can optionally terminate a license with any LEE 106 that fails to meet minimum sales or any other requirement set forth in the license. Similarly, LEE 106 can terminate a license with any LRE 108 for failure to comply with the terms of the agreement, where the license or agreement specifies the same. In exemplary embodiments, LREs 108 license their trademark, name, logo, mark, client or customer list, brand, business entity, business model, marketing tools, goodwill, and/or combinations thereof to LEEs 106. In a specific exemplary embodiment, LREs 108 may be a branded furniture or mattress business that licenses at least their name and marketing materials to a plurality of LEEs 106. The SEs 112 may be wholesale furniture or mattress manufacturers or distributors (e.g., SEALY® manufacturers, SERTA® manufacturers, La-Z-Boy® manufacturers, etc.) that sell furniture and/or mattresses to LEEs 106 at a wholesale price. LEEs 106 can then resell the goods consistent the terms of its license with LRE 108. Any other technology, tangibles, intangibles, goods, and/or services may be bought and sold via implementing the automated licenses described herein, not just furniture or mattresses. For example, the license may be for the sale of software, intellectual property, and/or technology in addition to licensing the brand or business. SEs 112 may distribute and LEEs 106 may sell furniture (indoor or outdoor furniture), mattresses, food, clothing, shoes, chemicals, technology, devices, software, vehicles, cosmetics, or any other type of tangibles or intangibles not inconsistent with the instant disclosure.

Still referring to FIG. 1 and in some embodiments, CEs 110 can request and schedule appointments with LEEs 106 to view the goods or services being sold. CEs 110 are consumers, clients, or customers of LEEs 106. CEs 110 can send a calendar request to MP 120 requesting a meeting with a specified LEE 106. MP 120 can then send the request to the specified LEE 106 calendar the request on the specified LEEs 106 master calendar. In some instances, MP 120 is also configured to send reminders to CE 110 and/or LEE 106 regarding scheduled appointments via messaging (e.g., a Short Message Service (SMS) message, a Multimedia Messaging Service (MMS) message, an email, an automated phone call and/or message, etc.). Notably, MP 120 is a centralized server or computing platform by which leads, licenses, sales, distributions, and/or appointments are managed and automated. Multiple different and/or discrete entities can interact and employ MP 120 to electronically manage various aspects of a business, including aspects associated with a business's operations and sales, such as managing leads, automating licensing, calendaring of appointments, and/or automating distributions.

Notably, MP 120 is a special purpose computing device or machine that includes hardware components (e.g., one or more processor units, memory, and network interfaces) configured to execute hardware and software elements (e.g., APIs, computing modules, etc.) for the purposes of performing one or more aspects of the subject matter set forth herein. In addition, it should be noted that MP 120 and its components and/or functionality described herein constitute a special purpose computer that improves the technological field of electronic lead recruiting, lead management, and automated license formation and/or termination by obviating the need to manually manage leads, determine satisfaction of lead requirements, and/or approve licensees. MP 120 further provides mechanisms for electronically executing licenses and/or terminating licenses, automatically after a predetermined period of time, when any party to the license fails to comply with the terms of the license.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., MP 120 or some functionality thereof may be integrated with any of the other entities associated with architecture 100. Alternatively, the functionality of MP 120 may be separated and/or distributed across multiple computing nodes or machines.

FIG. 2 is a block diagram of a system, generally designated 125, for automated licensing, distribution, and sales according to some embodiments described herein. In some embodiments, the system comprises MP 120, which has at least one processor 122, at least one memory 124 (e.g., a memory component, element or device), and at least one communication interface 130. MP 120 is configured to utilize processor 122, memory 124, and interface 130 to execute software to send, receive, and/or exchange data (information) by or between LSEs 104, LEEs 106, LREs 108, CEs 110 and/or SEs 112. In some embodiments, packets or message traffic (e.g., requests, responses, etc.) is sent, received and/or otherwise communicated or exchanged between MP 120 and the other network entities via one or more communication interfaces 130 according to the methods described herein for providing an electronic alternative to manually managing/approving leads and forming licenses.

In some instances, the processor 122 is a microprocessor, such as a central processing unit (CPU), or any other hardware-based processor unit that is configured to execute and/or utilize software to communicate with the multiple entities (e.g., or servers associated therewith) for processing and managing leads, processing and managing sales/distributions, and forming licenses. Processor implements the subject matter described herein by processing computer readable media stored in the memory 124.

The memory 124 is configured to store software executed via processor 122, and can comprise, without limitation one or more disk memory devices, chip memory devices, programmable logic devices, random access memory (RAM), read only memory (ROM), optical read/write memory, cache memory, magnetic read/write memory, flash memory, and/or application specific integrated circuits. The processor 122 and memory 124 may be disposed on a single device or computing platform or distributed across multiple devices or computing platforms.

MP 120 further comprises a lead and license management module (LLMM) 126 and a sales, distribution and appointment management module (SDAMM) 128. Each module is executed by the processor 122 and stored in memory 124. LLMM 126 and SDAMM 128 can comprise hardware, software and/or firmware components for implementing automated licensing formation or termination and distribution of goods or services as described herein. In one exemplary implementation, LLMM 126 includes functionality for collecting lead information, managing lead information via verifying completion of lead requirements, executing licenses between licensors and licensees, automatically, in response to approval of a licensee by licensor, and/or terminating licenses when the terms of the license are not being satisfied by either party. SDAMM 128 includes functionality for managing sales, generating and reporting sales data, automating distribution requests, and scheduling appointments for customers and licensees. LLMIM 126 can execute licenses and/or manage leads using data 127. The data 127 may be input, output, generated and/or stored and accessed by LLMM 126. Such data 127 may include, without limitation, lead identifying information, lead requirement data, license information, license terms, etc.

Likewise, SDAMM 128 can manage sales, generate sales reports and data, and schedule appointments using data 139. The data 129 may be input, output, generated and/or stored and accessed by SDAMM 128. Such data 129 may include, without limitation, sales data, revenue data, tax data, appointment data, customer data, calendar data, customer identifiers, marketing data, etc. The data (i.e., 127 and 129) may be populated and stored in any type of storage element, component, or device, not limited to a database, a data table, a cache, a storage drive, or any other collection of records or information including pending transactional data for processing upon delivery of an ordered good or service.

Although only one communications interface 130 is illustrated, one or more additional communications interfaces 130 may also be provided whereby connections to the network 102 (FIG. 1) or other remote entities are established. That is, communications interface 130 may include an interface by which packet data messages are received, sent, and/or exchanged. MP 120 is a hardware computing device and/or a computing platform including a communications interface 130 by which the computing modules 126 and 129 send, receive, and/or exchange electronic data for developing leads, managing leads, forming licenses, terminating licenses, scheduling appointments, and/or requesting distribution of goods or services. MP 120 is configured to receive an indication that a lead is interested in entering a license with a licensor, indications that lead requirements are completed or not, and/or authorizing sales and distributions.

It will be appreciated that FIG. 2 is for illustrative purposes only and that various components and/or functions thereof as described above in relation to FIG. 2 may be changed, altered, added, or removed. For example, some components and/or functions may be separated or combined into one entity. Alternatively, the functionality of MP 120 may be distributed across multiple computing nodes, platforms, or machines.

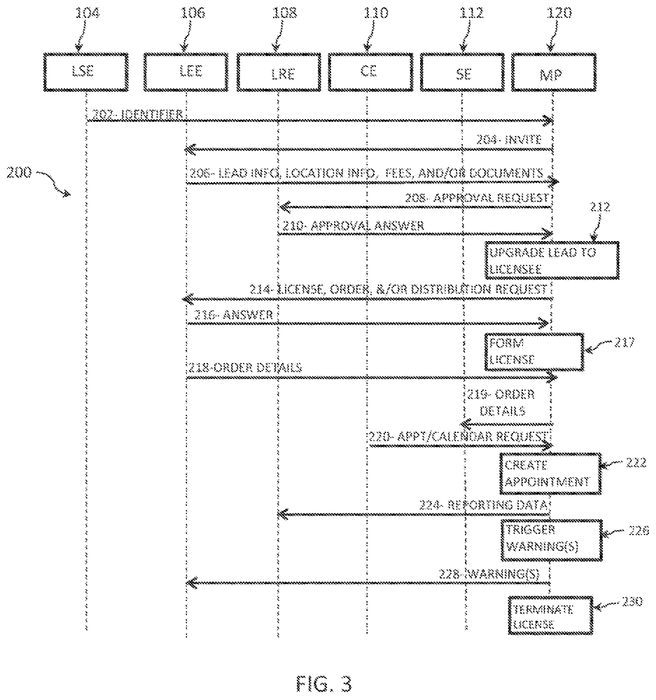

FIG. 3 is a message flow diagram illustrating exemplary messaging associated with a method, generally designated 200, for the automated licensing, distribution, and sales according an embodiment described herein. At 202, lead information is sent from LSE 104 to MP 120. The lead information can comprise a lead identifier received at MP 120. Exemplary lead identifiers include lead names, lead phone numbers, lead email addresses, usernames, a series of unique numbers and/or letters identifying leads, or any other type of identifying information associated with one or more leads.

At 204, MP 120 sends an invite to LEE 106. The invite can comprise instructions or a link by which LEE 106 can enroll or subscribe to MP 120. Upon enrolling or subscribing to MP 120, LEE 106 can transmit, send, or otherwise upload data or information each time a lead requirement is satisfied. For example, at 206, LEE 106 sends and MP 120 receives lead information, location information, fees, and/or other data, information, or documents necessary to indicate fulfillment of one or more lead requirements. Location information may include an address, lease, photographs, map information, a rental agreement, or a contract for the purchase, sale, lease, rental or other acquisition of real property (e.g., for use as a showroom, an office, etc.) as required by LRE 108. LRE 108 may require submission of such data, information, photographs, or documents prior to approving LEE 106 as a licensee and/or prior to forming a license with LEE 106. MP 120 is configured to manage, collect, store, aggregate, track, and/or verify the satisfaction, completion, and/or fulfillment of various lead requirements by LEE 106.

At 208, MP 120 determines that all of the lead requirements (or a sufficient number thereof) are fulfilled and automatically sends an approval request to LRE 108. At 210, LRE 108 sends an approval answer, by which LRE 108 either approves or disapproves upgrading a lead to a licensee. At 212, the lead is approved as a licensee and upgraded.

At 214, MP 120 automatically sends a license and request to LEE 106, the approved licensee. Simultaneously with sending the license, MP 120 may also send an order and distribution request by which LEE 106 places an initial order for goods or services. At 216, LEE 106 agrees to enter a license agreement with LRE 108 and a license is formed at 217. The license may include various terms or conditions which, if not satisfied, may result in the automatic termination of the license by MP 120.

At 218, LEE 106 places an order by sending order details to MP 120. Such order details may include, without limitation, the type of good being ordered, the quantity of goods being ordered, the brand name of goods being ordered, part numbers for goods being ordered, delivery instructions or details for the one or more goods or services being ordered, or any other information not inconsistent with the instant disclosure. MP 120 can track and store such order details. At 219, MP 120 sends the order details to SE 112, the supplier or manufacturer of the goods or services. Upon receiving the order, SE 112 will send and/or deliver the purchased goods and/or services to LEE 106.

At 220, CE 110 requests an appointment and sends a calendar request to MP 120. At 222, MP 120 creates the appointment and notifies LEE 106 and CE 110 of the appointment details. MP 120 is configured to send one or more reminders to LEE 106 and/or CE 110 in advance of the appointment, in some cases. Further, if CE 110 fails to make a purchase during the scheduled appointment, MP 120 can send one or more reminders or incentives to CE 110 for inviting CE 110 to make a purchase.

At 224, MP 120 transmits or sends reporting records or data to LRE 108. Such data may include sales and ordering data, total sales, monthly/weekly sales, gross/net sales data, gross/net profit data, debt data, budget data, overhead data, distribution data, appointment data, or any data or other information as requested by LRE 108 and/or as set forth in the license.

At 226, MP 120 determines, via tracking, for example, sales and/or order data, that LEE 106 is not complying with the terms of the license, and triggers one or more warnings 226. Warnings may be triggered, for example, where LEE 106 fails to make any sales over a given period of time or fails to place any orders or send distribution requests for goods/services over a specified period of time. LRE 108 and/or LEE 106 may set or specify various warnings to track and monitor the other party's compliance with the terms of the license. At 228, MP 120 sends the warnings to LEE 106. At 230, MP 120 terminates the license between LEE 106 and LRE 108. Although not shown, the warnings may also be sent to LRE 108 and the license may be terminated in instances where LRE 108 fails to comply with the duties or tasks identified in the license. The warnings transmitted at 228 may specify a time period by which LEE 106 (or LRE 108) can meet the terms of the license. Upon expiration of the specified time period, the lease can be automatically terminated by MP 120.

It will be appreciated that FIG. 3 is for illustrative purposes only and that various messaging and/or aspects thereof as described above in relation to FIG. 3 may be changed, altered, added, or removed. The messaging depicted in FIG. 3 may include additional/subsequent messaging as described herein, and some messaging may be combined or separated. Notably, MP 120 is configured to manage and track multiple (e.g., hundreds, thousands, etc.) leads per month/year/etc., and monitor the status of multiple licenses for improved license consistency and formation.

A non-limiting example regarding the instant subject matter is provided below. Numerous modifications and adaptations will be apparent to those of skill in the art without departing from the instant disclosure.

### Example 1

### Licensing an Outdoor Furniture Business

In one non-limiting example, an automatic license for an outdoor furniture business is formed via the methods, systems, and computer readable media set forth herein. Data regarding a potential licensee (i.e., a “lead”) of the business is sent to the management platform. The data may be sent to the management platform by a lead source, such as a clearing house, a recruiter, a dealer, a franchise site, the potential licensor, etc. The management platform will then contact the lead using the information provided by the lead source and prompt the lead to subscribe or set up an account with the platform.

Once the lead subscribes to and/or establishes an account with the management platform, the platform will then prompt the lead to submit various documents, fees, data, information, etc., to the platform to satisfy various lead requirements that are set or established by the business licensor. For example, the business licensor may require a fee, a city and state for a proposed business location, a picture of the proposed business location (e.g., a picture of a storefront, building, etc.), and the geographical location (address) of the proposed business location. The licensor may further require verification that the lead has registered with the secretary of state for approval to form a business in the state, established tax/IRS accounting numbers or identifiers for the business, established a business banking account, has acquired insurance, or the like.

Upon satisfactorily completing all (or a specified amount) of the lead requirements, the management profile will then prompt the business licensor to approve or disapprove of the lead and extend a license agreement. Once the license is approved and accepted by the licensee, a license will automatically form between the business licensor and the lead, which is now upgraded to an outdoor furniture business licensee. The license may allow the licensee to access various data, accounting information, software, websites, customer lists, marketing materials, copyrights, trademarks, or any other tangible or intangible asset as specified in the license. Upon formation of the license, the licensee will also be automatically prompted to place an initial order for pieces of outdoor furniture to sell and/or showcase in their place of business. The order will be communicated to one or more furniture manufacturers (i.e., Harmonia Living®, Gloster®, etc.), who will then ship the outdoor furniture to the licensee for the licensee to sell.

Customers may then access the management platform (e.g., via a phone, computer, etc.) to schedule appointments to view the outdoor furniture for sale in the licensee's showroom. The management platform can generate and send calendar requests to both customers and licensees to set appointments. The management platform can also communicate reminders to the customers and licensee prior to the scheduled appointment.

During the appointment, the customer may purchase outdoor furniture. The licensee can replenish sold inventory by ordering more furniture using the management platform. Where the customer does not make a purchase, the management platform may follow up (e.g., via a text message, an email message, etc.) with the customer after a predetermined amount of time to send offers, deals, or incentives prompting the customer to make a purchase. For example, where a customer does not purchase an outdoor dining set during a scheduled appointment, the management platform can send the customer a text message within 24 hours offering an incentive, such as perhaps a free outdoor umbrella, upon purchase, a percentage off of the purchase, etc. The management platform can communicate sales, business, and/or customer data to the business licensor, where desired.

The management platform can also terminate the license, should the licensee or the licensor fail to comply with the terms of the license. For example, if a licensee does not place a single order for outdoor furniture within a given amount of time (e.g., 2 weeks, 4 weeks, 6 weeks, etc.) then the license may be terminated. Further, if the licensee does not place an order for a certain quantity of outdoor furniture (e.g., 5 chairs, 10 chairs, etc.) or dollar amount of inventory ($500 worth of inventory, $1000 worth of inventory, etc.), then the licensed may be terminated. The licensee may receive one or more warnings prior to license termination. The terms and conditions for terminating a license will be agreed to by both parties upon license formation, and may vary per license, where desired.

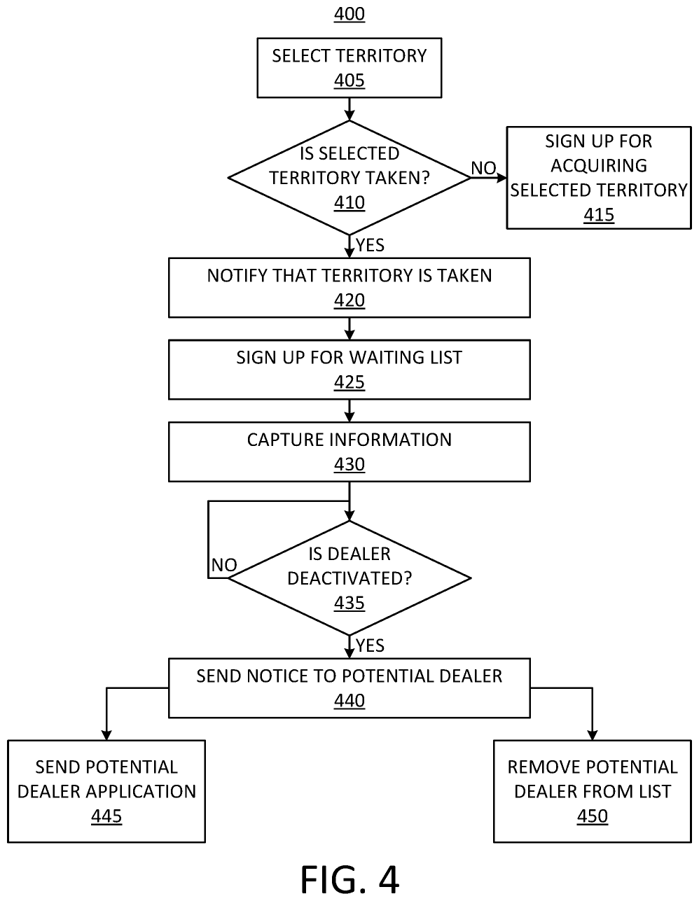

Referring now to FIG. 4, a flowchart of a method 400 for performing an automated and generally fully integrated waiting list feature is illustratively depicted, in accordance with various embodiments of the present disclosure.

At 405, a potential dealer selects a territory that they are interested in, via a graphical user interface. At 410, the system 125 may determine whether the selected territory is taken. If the selected territory is not taken, then, at 415, the potential dealer may sign up for acquiring that territory. If the selected territory is taken, the system 125, at 420, may notify the potential dealer that the selected territory is taken.

According to various embodiments, the system 125 may be configured to perform the automated and generally fully integrated waiting list feature. According to various embodiments, this automated and generally fully integrated waiting list feature may be configured to enable the potential dealer, at 425, upon obtaining knowledge that the selected territory they are interested in is taken, to sign up, via the graphical user interface, to a waiting list. According to various embodiments, the potential dealer may sign up via pressing a button, inputting information, and/or other suitable means. According to various embodiments, at 430, the system 125 may be configured to capture the potential dealer's information (e.g., name, email address, phone number, and/or other suitable information). It is noted that steps 425 and 430 may be performed separately and/or together.

At 435, the system 125 determines whether the dealer occupying the selected territory is deactivated. According to various embodiments, when the dealer occupying the selected territory is not deactivated, the system 125 may be configured to repeat the inquiry, at 435.

According to various embodiments, when the dealer occupying the selected territory is deactivated, then, at 440, the system 125 may be configured to automatically go into a waitlist queue and sends a Notice of Territory Availability to the potential dealer. According to various embodiments, the system 125 may then be configured to, at 445, send the potential dealer an application to sign up for acquiring the selected territory, or, at 450, remove the potential dealer from the waiting list.

According to various embodiments, as part of sending the potential dealer the application to sign up or removing the potential dealer from the waiting list, it may be determined whether one or more lead requirements has been satisfied by the potential dealer. Additionally, an electronic approval request for the lead identifier may be sent by a management platform, an answer responding to the electronic approval request may be received at the management platform.

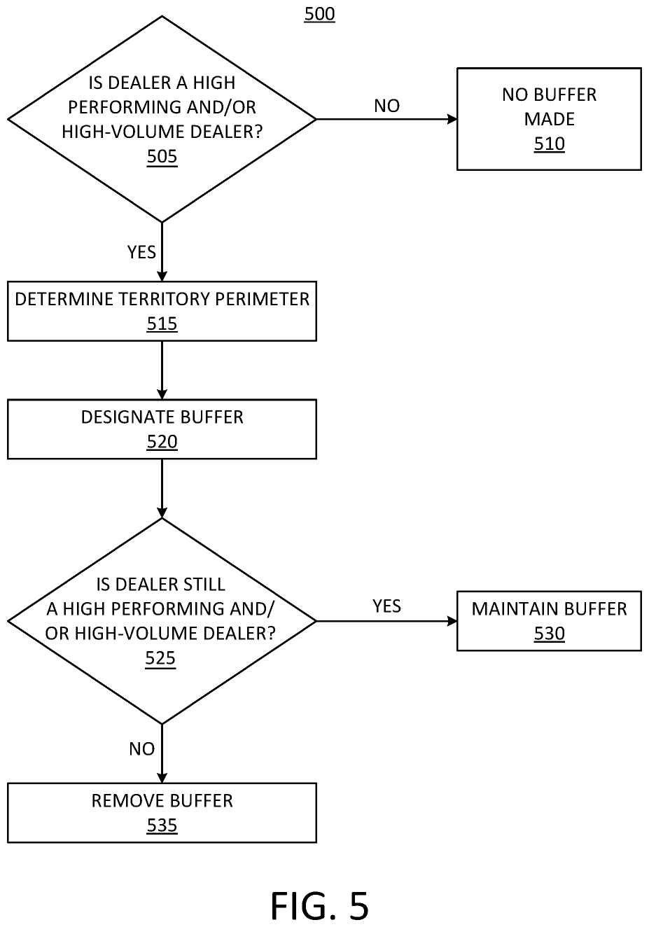

Referring now to FIG. 5, a flowchart of a method 500 for performing an automated and generally fully integrated radius buffer feature is illustratively depicted, in accordance with various embodiments of the present disclosure.

According to various embodiments, the system 125 may be configured to perform the automated and generally fully integrated radius buffer feature, wherein an existing territory may be customized to create a buffer around the existing territory where there is a high performing and/or high-volume dealer. This buffer region prevents any other potential dealers from reserving territory too close the territory of the high performing and/or high-volume dealer.

At 505, it is determined whether a dealer is a high performing and/or high-volume dealer. When the dealer is not a high performing and/or high-volume dealer, then, at 510, no buffer is made to the dealer's territory. When the dealer is determined to be a high performing and/or high-volume dealer, then, at 515, a perimeter of the high performing and/or high-volume dealer is determined and, at 520, a buffer zone a designated around the high performing and/or high-volume dealer's territory perimeter.

According to various embodiments, at 525, it may be determined whether the dealer is still a high performing and/or high-volume dealer. If the dealer still is a high performing and/or high-volume dealer, then, at 530, the buffer is maintained. If the dealer is no longer a high performing and/or high-volume dealer, then, at 535, the buffer is removed.

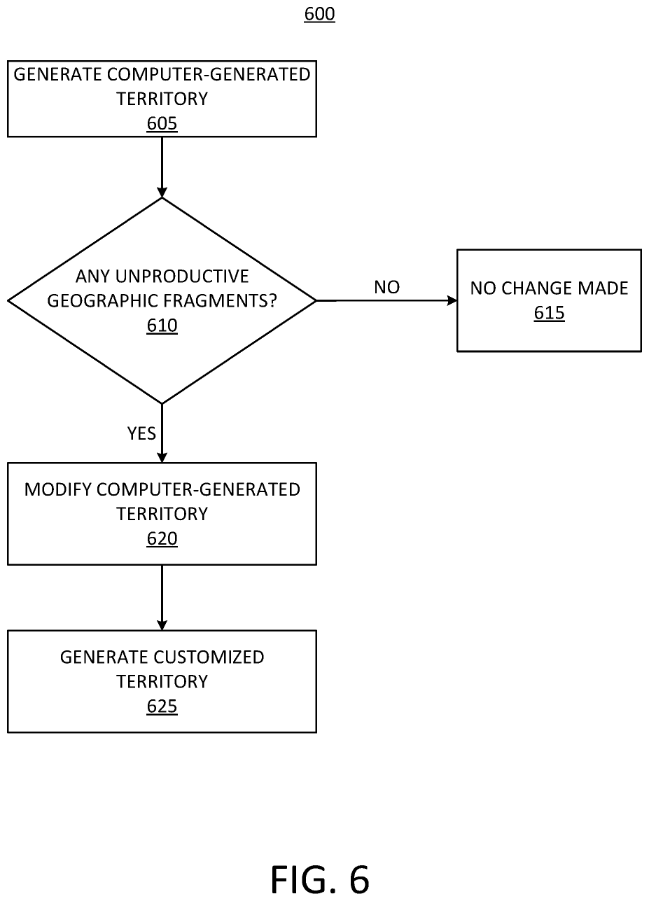

Referring now to FIG. 6, a flowchart of a method 600 for performing an automated and generally fully integrated radius adjustment override feature is illustratively depicted, in accordance with various embodiments of the present disclosure.

According to various embodiments, the system 125 may be configured to perform the automated and generally fully integrated radius adjustment override feature, wherein a computer-generated territory may be modified and/or customized. The computer-generated territory may be generated to have a radius around a dealer's location which includes a set approximate population. According to various embodiments, the computer-generated territory may be set to have a radius around the dealer's location which includes a population of approximately 100,000 people. It is noted, however, that other population quantities may be incorporated while maintaining the spirit and functionality of the present disclosure.

At 605, the computer-generated territory is generated. At 610, it is determined whether the computer-generated territory contains any unproductive geographic fragments. These unproductive geographic fragments may comprise areas within the computer-generated territory with little or no population. For example, sometimes when the computer generates the population radius, there may be a section enclosing a large body of water, such as a lake, river, or the ocean.

If the computer-generated territory contains no unproductive geographic fragments, then, at 615, no change to the computer-generated territory is made.

If the computer-generated territory contains one or more unproductive geographic fragments, then, at 620, the computer-generated territory may be modified, generating, at 625, a customized territory to avoid having fragments of the region uncovered by dealer territories.

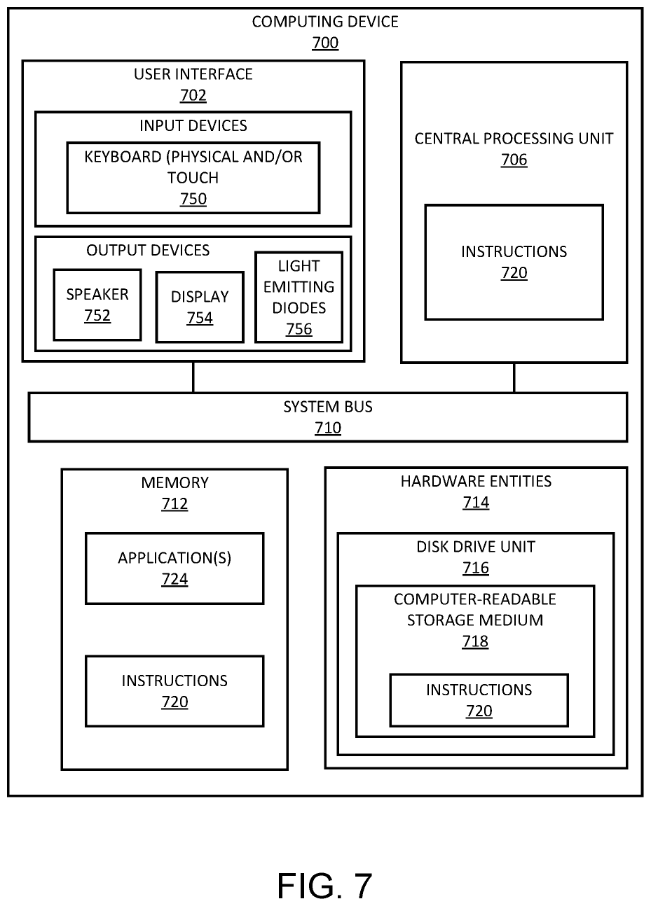

Referring now to FIG. 7, an illustration of an example architecture for a computing device 700 is provided. According to various embodiments, one or more functions of the present disclosure may be implemented by a computing device such as, e.g., computing device 700 or a computing device similar to computing device 700.

The hardware architecture of FIG. 7 represents one example implementation of a representative computing device configured to perform one or more methods and means for performing automated licensing, distribution, and sales, as described herein. As such, the computing device 700 of FIG. 7 may be configured to implement at least a portion of the method(s) described herein (e.g., message flow diagram 200, method 400, method 500, and method 600) and/or implements at least a portion of the functions of the system(s) and/or system architecture(s) described herein (e.g., system architecture 100 of FIG. 1, system 125 of FIG. 2).

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 700 may comprise a user interface 702, a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media,” as used here, refers to a single medium or multiple media (e.g., a centralized or distributed database, and/or associated caches and servers) that store the one or more sets of instructions 720. The term “machine-readable media,” as used here, also refers to any medium that is capable of storing, encoding or carrying a set of instructions 720 for execution by the computing device 700 and that cause the computing device 700 to perform any one or more of the methodologies of the present disclosure.

It will be understood that various details of the subject matter described herein may be changed without departing from the scope of the subject matter described herein. Furthermore, the foregoing description is for the purpose of illustration only, and not for the purpose of limitation.

The embodiments described in the present disclosure may relate to a system, a method, and/or a computer program product. The computer program product may include a computer readable storage medium (or media) having computer readable program instructions for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions, cloud storage, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a non-transitory computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the embodiments may be instruction-set-architecture (ISA) instructions, machine instructions, machine dependent instructions, microcode, firmware instructions, state-setting data, or either source code or object code written in any combination of one or more programming languages, including an object oriented programming language such as C++ and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more cases, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments described in the present disclosure.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by non-transitory computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may be executed substantially concurrently, the blocks may sometimes be executed in the reverse order, depending upon the functionality involved, or the blocks may sometimes be executed out of order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts or carry out combinations of special purpose hardware and computer instructions.

The various embodiments described above are provided by way of illustration only and should not be construed to limit the claims attached hereto. It will be appreciated that one or more embodiments of the above-disclosed and other features and functions, or alternatives thereof, may be desirably combined into many other different systems or applications.

What is claimed is:

1. A method of automating licensing, distribution, and sales, the method comprising:
receiving, at a management platform, a lead identifier;
determining, at the management platform, whether one or more lead requirements has been satisfied by the lead identifier;
sending, by the management platform, an electronic approval request for the lead identifier;
receiving, at the management platform, an answer responding to the electronic approval request; and
in response to receiving the answer, automatically forwarding, by the management platform, an electronic license and distribution request to an entity associated with the lead identifier.

2. The method of claim 1, further comprising receiving, at the management platform, an indication that an initial lead requirement has been fulfilled by the entity associated with the lead identifier.

3. The method of claim 1, further comprising receiving and processing, at the management platform, an initial request for distribution of goods or services.

4. The method of claim 1, further comprising receiving, at the management platform, a calendar request, and scheduling, by the management platform, an appointment for the entity associated with the lead identifier.

5. The method of claim 1, further comprising periodically reporting, by the management platform, sales and distribution data associated with the lead identifier to a licensor.

6. The method of claim 5, further comprising:
determining, by the management platform, whether the sales and distribution data has been reported; and
sending, by the management platform, a warning in response to a lack of sales and distribution data associated with the lead identifier.

7. The method of claim 6, further comprising transmitting, by the management platform, a warning message to the entity associated with the lead identifier.

8. The method of claim 7, further comprising terminating, by the management platform, the license, electronically, with the entity associated with the lead identifier.

9. A system for automating licensing, distribution, and sales, the system comprising:
a management platform comprising a communications interface, a processor, and a memory storing instructions that, when executed by the processor, cause the processor to perform the steps of:
executing one or more computing modules stored in the memory for receiving a plurality of lead identifiers;
determining whether one or more lead requirements has been completed by the lead identifiers;
triggering transmission of electronic approval requests for the lead identifiers;
receiving answers to the electronic approval requests; and
in response to receiving the answers, automatically forwarding electronic license and distribution requests to entities associated with the lead identifiers.

10. The system of claim 9, wherein the lead identifiers include names or telephone numbers associated with a plurality of leads.

11. The system of claim 9, wherein a first lead requirement includes confirmation of securing a contract for a sale, lease, or rental of real property.

12. The system of claim 9, further comprising a database, a data table, a cache, or a storage drive.

13. The system of claim 12, wherein the instructions, when executed by the processor, further cause the processor to populate the database, the data table, the cache, or the storage drive with sales, order, and/or distribution data.

14. The system of claim 12, wherein the instructions, when executed by the processor, further cause the processor to populate the database, the data table, the cache, or the storage drive with customer data.

15. The system of claim 9, wherein the instructions, when executed by the processor, further cause the processor to schedule appointments for licensees.

16. The system of claim 15, wherein the instructions, when executed by the processor, further cause the processor to send reminders regarding the scheduled appointments.

17. The system of claim 9, wherein the instructions, when executed by the processor, further cause the processor to automatically terminate a lease where a licensee or licensor fail to meet the terms or conditions set forth in the lease.

18. A non-transitory computer readable medium, comprising:
a processor; and
a memory having stored thereon executable instructions that, when executed by the processor, cause the processor to perform the steps of:
receiving a lead identifier;
determining satisfaction of one or more lead requirements by the lead identifier;
triggering transmission of an electronic approval request for the lead identifier;
receiving an answer to the electronic approval request; and
automatically forwarding an electronic license and distribution request to an entity associated with the lead identifier in response to receiving the answer.

19. The non-transitory computer readable medium of claim 18, wherein the executable instructions, when executed by the processor, are further configured to cause the processor to perform the step of:
upon receiving the answer to the electronic approval request, generating a portal account, accessible on a graphical user interface, for the entity associated with the lead identifier.

20. The non-transitory computer readable medium of claim 19, wherein the portal account is configured to enable the entity to perform one or more of:
accessing compliance information; or
indicating one or more dealership changes.

21. The non-transitory computer readable medium of claim 20, wherein the one or more dealership changes comprise one or more of the following:
an addition of one or more associates;
an addition of a location;
a moving of a location;
a closing of a location; or
a selling of a location.

22. A method of automating licensing, distribution, and sales, the method comprising:
receiving, using a computing device comprising a processor and a memory, a selection of a territory from a potential dealer;
determining, using the computing device, whether the territory is taken;
when the territory is taken, signing up the potential dealer, using the computing device, to a waiting list;
determining, using the computing device, whether a dealer associated with the territory is deactivated;
when the dealer associated with the territory is deactivated, sending notice, using the computing device, to the potential dealer;
determining, at a management platform, whether one or more lead requirements has been satisfied by the potential dealer; and
sending, by the management platform, an electronic approval request for the potential dealer.

23. The method of claim 22, further comprising:
receiving, at the management platform, an answer responding to the electronic approval request; and
in response to receiving the answer, automatically forwarding, by the management platform, an electronic license and distribution request to an entity associated with the potential dealer.

24. The method of claim 23, further comprising:
a trigger configured to automatically generate an email address corresponding to the electronic approval request for the potential dealer.
